(19) United States
(12) Patent Application Publication
(10) Pub. No.: US 2005/0027822 A1
(43) Pub. Date: Feb. 3, 2005

(54) Method and system for providing secondary internet access features by intercepting primary browser window locators

(76) Inventor: Manuel Eslick Plaza, Huntington Beach, CA (US)

Correspondence Address: WEISS & MOY PC, 4204 NORTH BROWN AVENUE, SCOTTSDALE, AZ, 85251, US

(21) Appl. No.: 10/769,163

(22) Filed: Jan. 30, 2004

Related U.S. Application Data
(60) Provisional application No. 60/491,224, filed on Jul. 30, 2003.

(51) Int. Cl. G06F 15/16

(52) U.S. Cl. 709/218

(57) ABSTRACT

A method and system for providing secondary internet access features by intercepting primary browser window locators provides for informing and advertising to Internet users with content targeted to the locators activated by the user in a primary browser window. Advertisements or other relevant information are displayed in a secondary browser window after a locator match is detected in a list of targeted locators. The locator may be a URL activated by the user or may be a search key entered in a search engine or search directory search field. The locator is looked up in a local list and if the locator is present in the list, a secondary window may be activated that displays secondary content associated with the locator. If the locator is a next URL for the primary browser window, activation of the URL may be blocked. If a user activates a second locator in the secondary browser window, it may be transferred to the primary browser window and the secondary browser window may then be hidden.

### CROSS-REFERENCE TO RELATED APPLICATION

This application is related to U.S. provisional application Ser. No. 60/491,224, filed on Jul. 7, 2003 bearing the same title and from which it claims benefits under 35 U.S.C. §119(e).

### BACKGROUND OF THE INVENTION

1. Field of the Invention

The present invention is related to network user interfaces, and more particularly to a World-Wide-Web (WWW) browser that provides secondary Internet access features based on primary browser window activity.

2. Description of the Related Art

Public networks, and in particular the Internet provide an increasingly prevalent source of information as well as a means purchase of goods and services at home as well as in business. Internet browsers provide a user interface to a myriad of files located on servers, and the files represent web pages that can range from simple text displays to graphic and animated displays. Search engines and other search tools such as directory systems provide a mechanism for locating information as well as products and services on the Internet.

Sales on the Internet are generally provided by websites controlled by a seller of the particular goods or services. However, advertising intended to draw a buyer to the sales website or to a non-Internet sales outlet may be provided in many forms: targeted or non-targeted e-mail, advertisement banners provided from another web page or website, pop-ups provided through a website or via a hosting service or other party in the position to generate an overlay or pop-up as the Internet user or “surfer” activates a web page.

However, all of the above-described advertising mechanisms have related drawbacks, and generally are not related to the particular items that the Internet surfer might want to locate or purchase. Therefore, a primary Internet promotion strategy pursued by sources of information, goods or services is search engine optimization, attempting to place their website or web pages high in the search engine results rankings for particular search terms. But, search engine results are geographically general, do not provide much in the way of promotional ability through visual distinction (e.g., typically a search engine result is a few lines of information gleaned from the web page headers) and tend to be persistent beyond what is typically desired by an advertiser. Advertisement placement on a search engine home page is expensive, partially due to limited available space and does not tend to be persistent at all due to advertisement rotation. Further, such advertisement is generally not targeted either geographically or often with respect to a search engine query, therefore such advertisement tends to be ignored and if it is merely noted, can be difficult to re-locate after a user has moved on to another page.

Therefore, it would be desirable to provide a mechanism for advertising and otherwise informing a user, in particular a user that is searching for particular items via a search engine, in a manner that can be geographically targeted, is sufficiently but not excessively persistent, and is cost-effective.

### SUMMARY OF THE INVENTION

The above-stated objectives of advertising and otherwise informing a user, in particular a user of a search engine, in a manner that can be geographically targeted, is suitably persistent and is cost-effective are provided in a method and system for providing secondary Internet access features by intercepting primary browser window locators.

The method detects user activity in a primary browser window of a browser and if a locator is detected, it is parsed to determine a target of the locator. The target is then compared to a list of targets. If a match is found, a secondary browser window is activated and content is displayed that is associated with the target. The target may be a next URL of the primary browser window, or may be a search engine key. The target may be communicated to a server, which pushes content for display in the secondary browser window. Geographical information may also be pushed to the server, permitting selection of content at the server for display in the secondary browser window.

The method may be embodied in a computer program product containing program instructions for execution within a general-purpose computer system for carrying out steps of the method. The method may also be embodied in a general-purpose computer system executing the program instructions of the computer program product.

The foregoing and other objectives, features, and advantages of the invention will be apparent from the following, more particular, description of the embodiments of the invention, as illustrated in the accompanying drawings.

### BRIEF DESCRIPTION OF THE DRAWINGS

FIG. 1 is a block diagram depicting a networked computer system in which embodiments of the invention may be practiced.

FIG. 2 is a pictorial diagram depicting an Internet browser displayed on the graphical display of FIG. 1, having graphical output in accordance with an embodiment of the present invention.

FIG. 3 is block diagram depicting an organization of software and data in memory in accordance with an embodiment of the present invention.

FIG. 4 is a flowchart depicting operation of a client-side initialization process in accordance with an embodiment of the present invention.

FIG. 5 is a flowchart depicting operation of a client-side operational process in accordance with an embodiment of the present invention.

FIG. 6 is a flowchart depicting operation of a server-side process in accordance with an embodiment of the present invention.

### DETAILED DESCRIPTION OF THE EMBODIMENT OF THE INVENTION

The present invention concerns techniques for providing advertising and other features in response to detected activity in a main browser window. Component software on a user machine, provided as a browser plug-in (“browser helper object”) or other browser-interfaced component, generally a dynamic-linked library (DLL) is installed on the user machine and activated so that browser activity is detected and browser display and/or functionality are modified to provide a secondary browser display that can display advertising, information or other useful secondary display content in conformity with detected browser main window activity. The secondary browser display is functionally a stand-alone browser window that is drawn within the browser main window and the controlling program responds to information gathered from user activity within the main browser window, but is otherwise independent of the operation of the browser main window. Alternatively, the secondary browser window could be drawn separately as a layered window or a separate browser executable instance.

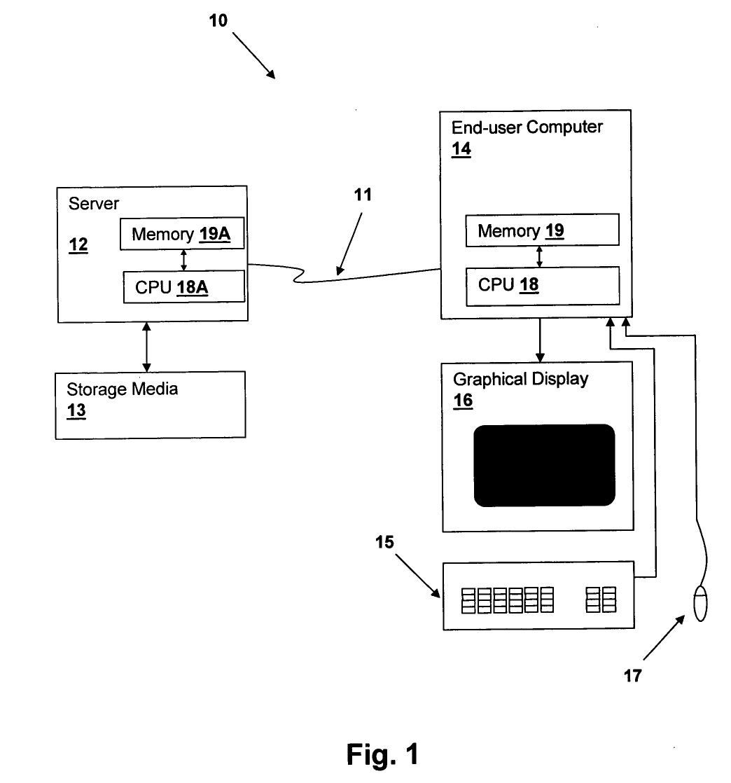

Referring now to FIG. 1, a system 10 in which embodiments of the present invention may be practiced is depicted in a block diagram. A server 12 is coupled to a signal-bearing media in the form of hard disk storage 13 having program instructions for practicing portions of a method in accordance with an embodiment of the present invention that are loaded into a memory 19A and executed by one or more central processing units 18A (CPU). Server 12 is coupled to an end-user computer 14 via network connection 11, which may be an Ethernet connection coupled to routers, bridges or other terminal equipment for connection to a wide-area network, and thereby to the Internet. Alternatively, network connection may be a modem, DSL or cable modem connection coupled to end-user computer 14 for direct connection to the Internet as is typical in home installations. As such, network connection 11 represents a connection to the Internet or other suitable platform for connection to remote systems such as server 12. The present is invention uses the network depicted in FIG. 1 to remotely deliver advertising and/or other content in response to activity of a browser executed by a processor (CPU) 18 from a memory 19 within end-user computer 14. When a user having access to end-user computer 14 coupled to network connection 11 browses the Internet via the executing browser, main browser window activity is detected and a secondary browser window may be activated or main browser window behavior modified in response to the detected main browser window activity.

End-user computer 14 contains is coupled to a graphical display 16 and input devices such as a keyboard 15 and mouse 17 providing interactivity with the browser program in order to provide access to the world-wide-web (WWW). Server 12 is accessed via the program of the present invention and may also be accessed directly by browser through the main browser window.

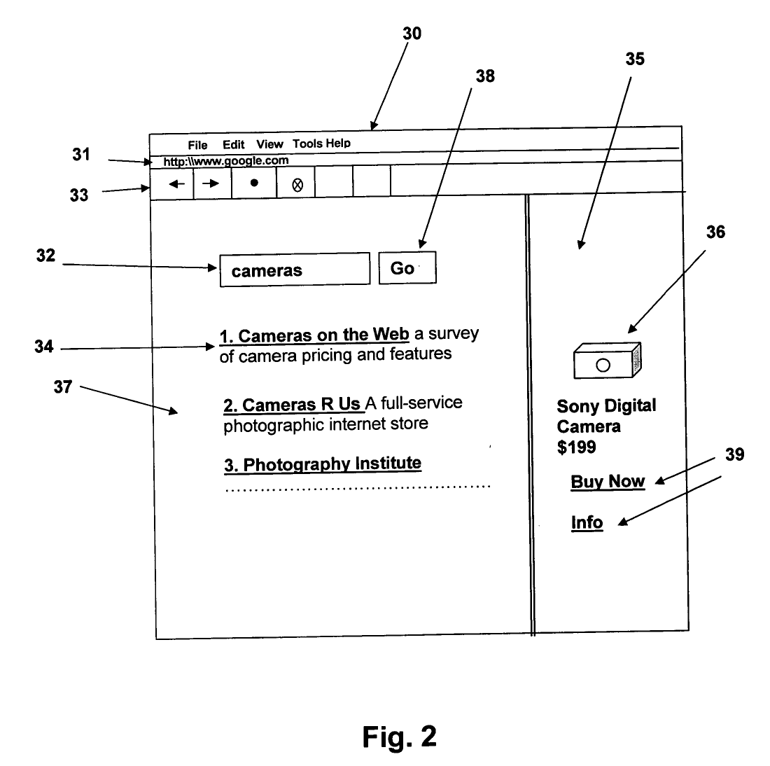

Referring now to FIG. 2, a user interface of a program and system in accordance with an embodiment of the present invention is depicted. A browser interface 30 includes a location area 31 for displaying the currently active URL, a toolbar 33 for navigating and a main browser window (content area) 37 for displaying the contents or programmatic response to a web page loaded from the Internet. Secondary browser window 35 is depicted as visible, but initially secondary browser window is not seen and main browser window 37 may extend to the area occupied in the figure by secondary browser window 35. Main browser window 37 is depicted as displaying the contents of a search engine web page interface including a query input area 32, a query activation button 38 and a list of search results 34 as is typically provided by a search engine, but the depicting should be understood to not limit the application of the techniques of the present invention to search engines having an interface as depicted. Prior to, or simultaneously with the display of search results 34 in main browser window 37 via a new search engine page load (a new URL or search engine URL that generally has a query string appended), secondary browser window 35 may be activated depending on the query and an advertisement 36 or other information displayed. Advertisement 39 contains links 39 to purchase and information options and other options may be provided in combination with other types of displays (information, alerts, etc.) as appropriate to the type of display in secondary browser window 35. If a user activates one of links 39, the content associated with the link will generally be loaded into main browser window 37 and secondary browser window 35 will once again be hidden, but the present invention also contemplates using secondary browser window 35 as the content display area, and in practice, main browser window 37 can be hidden or remain in place.

Information content provided by secondary browser window 35 may include terror alerts, weather information, traffic alerts, and other information that may be geographically selected based on a locale of the user. A feature of the system is the ability to determine locale via zip code query prompts, scanning cookies or other mechanism for determining local, and then providing content selected in conformity with the known locale. For example, the traffic and weather conditions as well as alerts can be selected for the region or a city and even non-Internet purchase directed advertising can be brought to local clients, so that retail stores and other vendors that are not selling only on the Internet or via mail-order can advertise goods or services to locals.

Another feature of the system enabled by the interception of browser universal resource locators (URLs) or access control lists (ACLs) is the ability to provide content filters as part of the operation of the system. The term URL or locator will be applied herein, but it should be understood that access can be made to URLs through an ACL or in general other mechanisms and the present invention is not limited to the mechanism by which a browser accesses content on the Internet, only requiring interpretation of the access locator via comparison to known values located in a local data store.

Content-filtering in the context of the present invention provides a client-side filtering that works in conjunction with the URL interception of the above-mentioned main browser window directives and the client-side software can selectively block Internet access to selected sites continuously or over particular time intervals, such as disabling access to non-approved Internet sites for employer-owned machines during business hours. The software can also block pop-up ads, as the instantiation of new URL windows is monitored by the software and can be prevented.

The client-side software intercepts a URL being activated in main browser window 37 and checks the intercepted URL against local data stores to determine if the URL is a filtered URL (non-approved URL) and/or a URL for which the secondary browser window 35 should be activated, permitting secondary browser window 35 to operate invisibly until a local trigger URL is detected as requested in the main browser window 37. Business logic and rule sets embedded in the local data stores provide rules for processing URLs comparing them to URL data sets in the local data stores. Generally, the URL is returned to main browser window 37 while any secondary information is provided in secondary browser window 35. But, for filtered sites and for other special purposes, the URL in main browser window 37 can be blocked and/or replaced with another URL looked up based on business rules in the local data stores.

Form entries can also be detected from the main browser window and in particular, the present invention is directed toward intercepting search form entries for search engines, so that a search query may be intercepted and processed for activating secondary browser window 35 in response to search queries identified by further business logic and rule sets within the local data stores. Search engine queries are usually formed as form data that can be intercepted or as query parameters in a URL. For query-containing URLs, business logic in the local data store indicates a mechanism for stripping the query parameters and interpreting them to determine the query string, yielding a result equivalent to intercepting the queries entered as form data.

Once a query has been identified as matching an entry in the local data store, information is passed from server 12 and an advertisement URL is returned from the server that can then be used by secondary browser window 35 to retrieve advertising content 36 from server 12. If a link 39 in the secondary browser window 35 is activated, the URL can be transferred to main browser window 37 and the underlying content loaded there with the secondary browser window 35 once again hidden from view. The information passed to server 12 on a detected query includes a query, the URL, and the search engine name. The information also may include an “affiliate” GUID, which is a GUID identifying a business affiliate (e.g. a reseller providing goods advertised in the secondary browser window content).

The data stores having the lists of URLs and queries identified in the present invention are maintained by periodically checking for updates on the server at the time of registration (initialization) of the browser helper component. Security is also provided through connection to server 12 and the identity of a user is generally verified once per day. A GUID is generated for each user each day and is passed to server 12 to identify and authenticate a user.

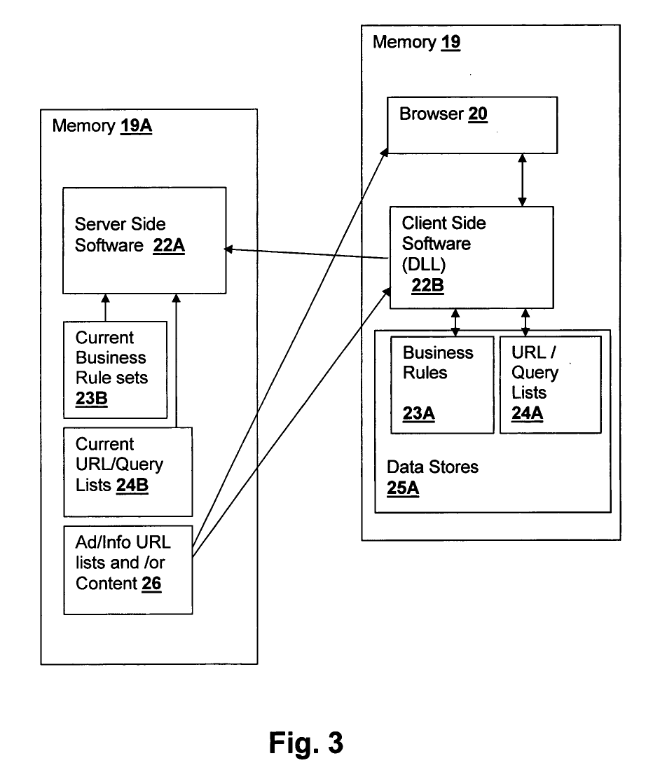

Referring now to FIG. 3, an organization of software modules in accordance with the present invention is depicted for server memory 19A and end-user computer memory 19. Client side software 22B within end-user computer memory 19 includes program instructions for interacting with server side software 22A within server memory 19A, as well as storing and retrieving information and logic within client-side data stores 25A. Client-side data stores include business rule sets 23A and lists 24A, that are downloaded on an as-needed upgrade basis from server 12, generally in response to detecting a version number deficiency at the first startup of the browser software (and thus client side software 22B) on a given day. Server-side software provides current lists 24B and current business rules 23B for updating data stores 25A within end-user memory 19 (that is then stored on permanent storage such as a hard drive in end-user computer 14). Lists 24A include lists of URLs and queries for which information exists for loading into secondary browser window 35. Advertising/Information content 26 is also contained within memory 19A, but may represent only lists of links to content on other servers rather than the actual content, that are then passed to client side software 22B for loading into secondary browser window 35. Client-side software 22B is also responsible for performing the filtering, cookie scanning, URL and query parsing (in conjunction with business rules 23A) described above.

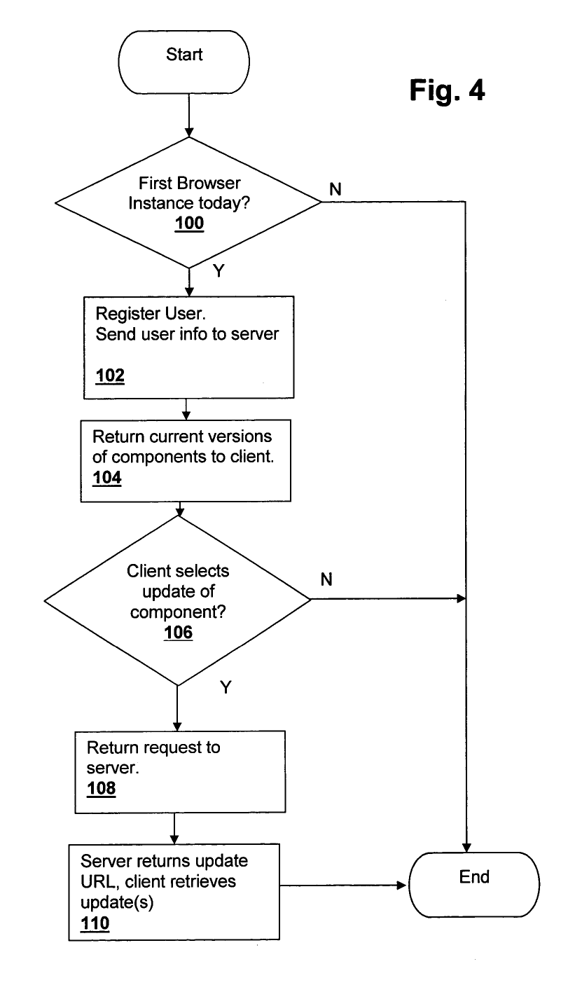

Referring now to FIG. 4, a process in accordance with operation of software in accordance with an embodiment of the invention is depicted. The depicted process is the registration process which is generally performed once per day. First, if the startup instance is the first instance of the browser for the day (decision 100), then the user is registered by returning user information to the server (step 102). The user information generally includes the user GUID, connection Type, Display Size, operating system (OS) version, browser version, a reseller ID, versions of the components of client-side software 22B and data stores 25A and information about any third-party spyware that is installed on the user's system. Next, the current versions of the components on server 12 (business rule sets 23B, URL/query lists 24B and client side software modules) are sent (step 104) to client side software 22B and the client determines which components to update (decision 106). If the client software 22B selects an update, the update request is returned to server (step 108), the server returns URLs of the update components (step 110) and client software 22B retrieves the updates and installs the udpates (step 110). At the end of registration, the client is initialized.

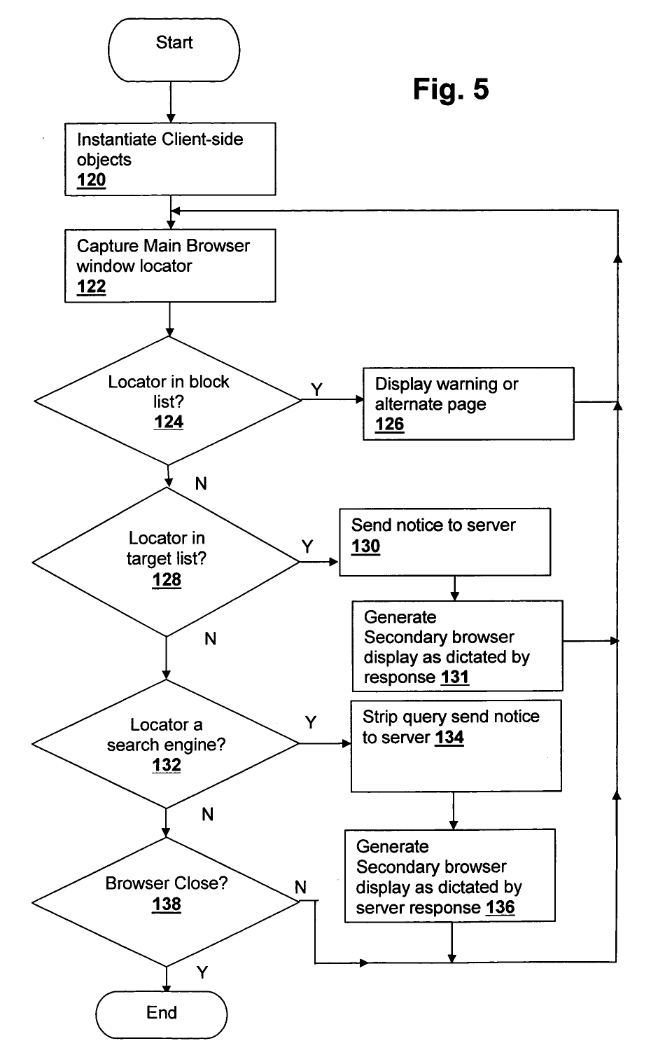

Referring now to FIG. 5, client software 22B running operation is depicted in a flowchart. First, after the initialization/update procedure described above, the client mode objects are instantiated (step 120). While the description herein refers to main browser window 37 and secondary browser window 35, it should be understood that the illustrative configuration is not limiting to the actual implementation of embodiments of the present invention. For example, it has been found convenient to instantiate a business logic component that that performs the main browser locator capture and sends it to a hidden window that is that is provided for the information/advertising display. The window is hidden normally and generates the secondary browser display in response to indications from the business logic component. The gist of the present invention is the functionality, and not the specific limitations of the embodiments described herein and variations thereon will be apparent to those skilled in the art.

The client object responsible for capturing main browser window captures locators as they are entered, triggered by browser navigation controls, or by directives from other operating system or applications links (step 122). Each locator is compared to several lists or a single list with directives, or otherwise processed by business rules 23A (e.g., a partial URL match in a business rule could be used to block access to many URLs). First, the locator is compared to the block list (decision 124) and if a match is found, a warning page or alternate page can be displayed in main browser window (step 126), or alternatively in secondary browser window with no change to the main browser window or hiding the main browser window. If the locator is not in the block list (decision 124), then the locator is searched in the target list (step 128) and if a match is found a notice (that may include URL target, screen size, reseller ID and connection speed) is sent to server (step 130) which supplies a response that may include advertisers URL, advertiser ID and formatting information that dictates an advertisement/information that is be displayed in secondary browser window (step 131). Next, if the locator is a search engine (decision 132), then the query is stripped when received and notice (that may include search engine name, query, screen size, page number, reseller ID and connection speed) is sent (step 134) to the server. The server responds with a search engine template and advertisement/information display URLs and formatting information and the secondary display is generated (step 136). Alternatively, target match or query match window generation (steps 131 and 136) may post directly to the main browser window, or may wait for activation of a link within the secondary browser window. The process above is repeated until the browser is closed (step 138) upon which the client-side objects are destroyed and the process ended.

The above server notices may also include ZIP code or other geographical identifiers and the advertisements or other information may be selected in conformity with the geographical locale of the user and supplied for display in the secondary browser window or main browser window. The zip code as mentioned above, can be collected from scanning cookies or during a form entry in the registration process or by other means.

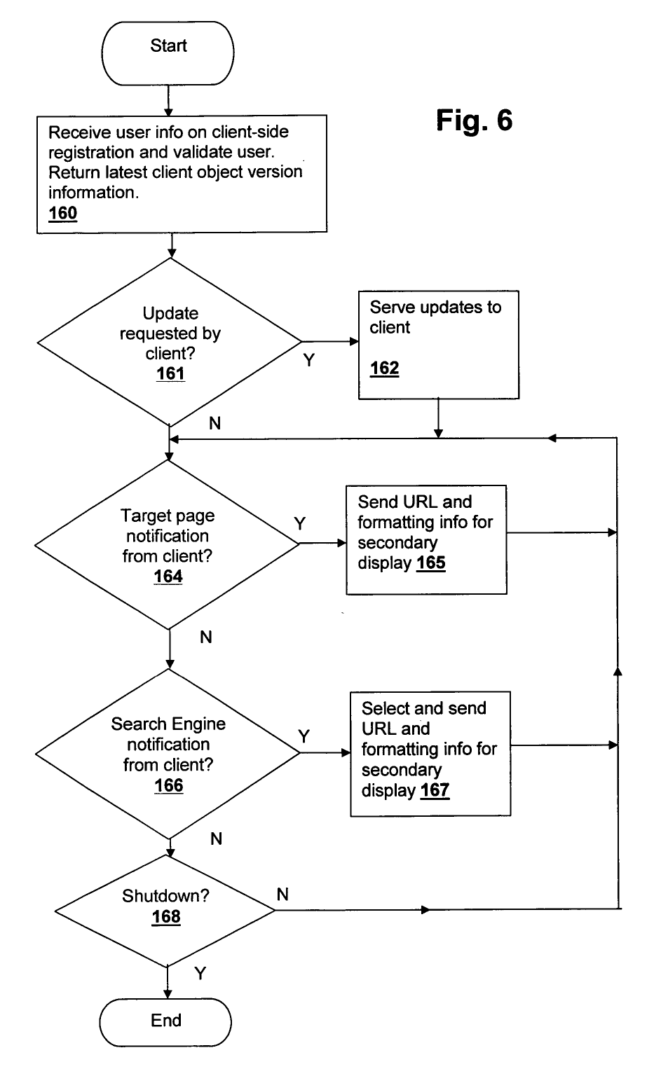

Referring now to FIG. 6, a server-side process in accordance with an embodiment of the invention is depicted in a flowchart. During the registration process mentioned above, server-side software 22A receives the user GUID and other information and validates the user (step 160), supplying current version information for current URL/query lists 24B and business rule sets 23B. Updates are served (step 162) if requested (decision 161) by the client and the client updates itself as described above. Server-side software 22A receives notices from client-side software 22B upon target matches (decision 164) and provides URL and formatting information for advertisments and/or information that permit the client to display the advertisements and/or information in the secondary browser window (step 165). Server-side software 22A also receives notices upon search engine queries (decision 166) and provides a search engine template including URL and formatting information for advertisments and/or information that permits the client to display the advertisements and/or information in the secondary browser window in response to the received query information and search engine name (step 167). The server side process continues unless shut down (decision 168).

While the invention has been particularly shown and described with reference to the preferred embodiments thereof, it will be understood by those skilled in the art that the foregoing and other changes in form, and details may be made therein without departing from the spirit and scope of the invention.

1. A method of operating a browser executing within a general-purpose computer system, said method comprising:
detecting user activity within a main browser window of said browser;
parsing said detected activity to determine a target of said detected activity;
comparing said target to determine whether or not said target is in a list of pre-selected targets;
in response to said comparing determining that said target is in said list, activating a secondary browser window; and
displaying content associated with said target in said secondary browser window.

2. The method of claim 1, further comprising:
second detecting a second user activity within said secondary browser window; and
responsive to said second detecting, transferring a locator associated with said second user activity to said primary browser window, whereby content associated with said second user activity is displayed in said primary browser window.

3. The method of claim 2, further comprising hiding said secondary browser window in response to said second detecting having detected a second user activity corresponding to a second target for which all responsive content is targeted for display in said primary browser window.

4. The method of claim 1, wherein said detecting further detects an active locator of said primary browser window and wherein said parsing determines said target from said user activity and said active locator.

5. The method of claim 4, wherein said active locator is a locator of a search engine, said user activity comprises entry of a search engine key and wherein said target is a search engine result of said search engine for said search engine key, and wherein said displaying displays content associated with said search engine key.

6. The method of claim 1, wherein said target is a link containing a next locator for said primary browser window, and further comprising blocking said primary browser window from activating said next locator in response to a result of said comparing.

7. The method of claim 1, wherein said target is a link containing a next locator for said primary browser window, and wherein said displaying displays content associated with said next locator.

8. The method of claim 1, further comprising:
transmitting a result of said comparing to a server; and
pushing content from said server in response to reception of said result of said comparing, and wherein said displaying displays said pushed content.

9. The method of claim 1, further comprising:
transmitting a result of said parsing to a server; and
pushing content from said server in response to reception of said result of said parsing, and wherein said displaying displays said pushed content.

10. The method of claim 1, further comprising second detecting a geographical location associated with a user of said general-purpose computer system, and wherein said displaying displays content associated with said target and filtered by said geographical location in said secondary browser window.

11. The method of claim 10, further comprising:
transmitting a result of said parsing to a server along with an indication of said geographical location;
selecting content in conformity with said geographical location and said result of said parsing; and
pushing said selected content from said server, whereby said displaying displays said pushed content selected in conformity with said geographical location.

12. A computer system comprising:
a processor for executing program instructions, a memory for storing said program instructions and data;
browser program instructions for providing an Internet browser executed by said processor from said memory; and
browser helper program instructions, wherein said browser helper program instructions comprise program instructions for:
receiving an indication of user activity within a main browser window of said browser from said browser program instructions,
parsing said detected activity to determine a target of said detected activity,
comparing said target to determine whether or not said target is in a list of pre-selected targets,
in response to said comparing determining that said target is in said list, activating a secondary browser window, and
displaying content associated with said target in said secondary browser window.

13. The computer system of claim 12, wherein said browser helper program instructions further comprise program instructions for:
detecting a second user activity within said secondary browser window; and
responsive to said detecting, transferring a locator associated with said second user activity to said browser program instructions, whereby content associated with said second user activity is displayed in said primary browser window.

14. The computer system of claim 13, wherein said browser helper program instructions further comprise program instructions for hiding said secondary browser window in response to said program instructions for detecting having detected a second user activity corresponding to a second target for which all responsive content is targeted for display in said primary browser window.

15. The computer system of claim 12, wherein said browser helper program instructions for receiving further receive an active locator of said primary browser window and wherein said browser helper program instructions for parsing determine said target from said user activity and said active locator.

16. The computer system of claim 15, wherein said active locator is a locator of a search engine, said user activity comprises entry of a search engine key and wherein said target is a search engine result of said search engine for said search engine key, and wherein said browser helper program instructions further comprise program instructions for displaying display content associated with said search engine key.

17. The computer system of claim 12, wherein said target is a link containing a next locator for said primary browser window, and wherein said browser helper program instructions further comprise program instructions for directing said browser program instructions to block said primary browser window from activating said next locator in response to a result of said comparing.

18. The computer system of claim 12, wherein said target is a link containing a next locator for said primary browser window, and wherein said browser helper program instructions for displaying display content associated with said next locator.

19. The computer system of claim 12, wherein said computer system is coupled to a server via the Internet, and wherein said browser helper program instructions further comprise program instructions for:
transmitting a result of said comparing to said server; and
receiving pushed content from said server sent in response to reception of said result of said comparing, and wherein said program instructions for displaying display said pushed content.

20. The computer system of claim 12, wherein said computer system is coupled to a server via the Internet, and wherein said browser helper program instructions further comprise program instructions for:
transmitting a result of said parsing to said server; and
receiving pushed content from said server sent in response to reception of said result of said comparing, and wherein said program instructions for displaying display said pushed content.

21. The computer system of claim 12, wherein said browser helper program instructions further comprise program instructions for detecting a geographical location associated with a user of said general-purpose computer system, and wherein said browser helper program instructions for displaying display content associated with said target and filtered by said geographical location in said secondary browser window.

22. The computer system of claim 21, wherein said computer system is coupled to a server via the Internet, said server having a processor for executing server program instructions and a memory for storing said program instructions, and wherein said server program instructions comprise program instructions for:
receiving a result of said parsing along with an indication of said geographical location;
selecting content in conformity with said geographical location and said result of said parsing; and
pushing said selected content to said computer system, whereby said displaying displays said pushed content selected in conformity with said geographical location.

23. A computer program product comprising signal-bearing media for execution within computer system comprising browser helper program instructions for implementing a browser helper object for adding functionality to a browser executed within said computer system, said browser helper program instructions comprising program instructions for:
receiving an indication of user activity within a main browser window of said browser from said browser,
parsing said detected activity to determine a target of said detected activity,
comparing said target to determine whether or not said target is in a list of pre-selected targets,
in response to said comparing determining that said target is in said list, activating a secondary browser window, and
displaying content associated with said target in said secondary browser window.

24. The computer program product of claim 23, wherein said browser helper program instructions further comprise program instructions for:
detecting a second user activity within said secondary browser window; and
responsive to said detecting, transferring a locator associated with said second user activity to said browser, whereby content associated with said second user activity is displayed in said primary browser window.

25. The computer program product of claim 24, wherein said browser helper program instructions further comprise program instructions for hiding said secondary browser window in response to said program instructions for detecting having detected a second user activity corresponding to a second target for which all responsive content is targeted for display in said primary browser window.

26. The computer program product of claim 23, wherein said browser helper program instructions for receiving further receive an active locator of said primary browser window and wherein said browser helper program instructions for parsing determine said target from said user activity and said active locator.

27. The computer program product of claim 26, wherein said active locator is a locator of a search engine, said user activity comprises entry of a search engine key and wherein said target is a search engine result of said search engine for said search engine key, and wherein said browser helper program instructions further comprise program instructions for displaying display content associated with said search engine key.

28. The computer program product of claim 23, wherein said target is a link containing a next locator for said primary browser window, and wherein said browser helper program instructions further comprise program instructions for directing said browser to block said primary browser window from activating said next locator in response to a result of said comparing.

29. The computer program product of claim 23, wherein said target is a link containing a next locator for said primary browser window, and wherein said browser helper program instructions for displaying display content associated with said next locator.

30. The computer program product of claim 23, wherein said computer system is coupled to a server via the Internet, and wherein said browser helper program instructions further comprise program instructions for:
transmitting a result of said comparing to said server; and
receiving pushed content from said server sent in response to reception of said result of said comparing, and wherein said program instructions for displaying display said pushed content.

31. The computer program product of claim 23, wherein said computer system is coupled to a server via the Internet, and wherein said browser helper program instructions further comprise program instructions for:
transmitting a result of said parsing to said server; and
receiving pushed content from said server sent in response to reception of said result of said parsing, and wherein said program instructions for displaying display said pushed content.

32. The computer program product of claim 23, wherein said browser helper program instructions further comprise program instructions for detecting a geographical location associated with a user of said general-purpose computer system, and wherein said browser helper program instructions for displaying display content associated with said target and filtered by said geographical location in said secondary browser window.
